(19) United States
(12) Patent Application Publication
(10) Pub. No.: US 2001/0023376 A1
(43) Pub. Date: Sep. 20, 2001

(54) Parts information management method and parts information management system

(76) Inventors: Jinichi Uchida, Nagoya-city (JP); Takao Kuno, Hekinan-city (JP); Kanehisa Hattori, Ama-gun (JP)

Correspondence Address: Larry S. Nixon, Esq., NIXON & VANDERHYE P.C., 8th Floor, 1100 North Glebe Rd., Arlington, VA, 22201-4714, US

(21) Appl. No.: 09/799,126

(22) Filed: Mar. 6, 2001

(30) Foreign Application Priority Data
Mar. 16, 2000 (JP) 2000-74467

(51) Int. Cl. G06F 19/00; G06F 17/60; G06F 7/00; G06F 17/00

(52) U.S. Cl. 700/101; 700/99; 705/8; 707/102; 707/200

(57) ABSTRACT

The present invention provides a parts information management method and a parts information management system which allows efficient and optimal activities to be done when developing and improving a product. The parts information network in a specific organization is integrated with the parts information network outside the organization. The input device of a network terminal may be used to input information with respect to part specifications to be searched. Any parts which satisfy the input specification are gathered from the parts information network. Then the display device of a network terminal may be used to list a plurality of parts in the predetermined priority order. The priority may be determined based on the distribution records so as to place the examination results in the specific organization at the top priority.

### CROSS-REFERENCE TO RELATED APPLICATION

The present invention is related to Japanese patent application No. 2000-74467, filed Mar. 16, 2000; the contents of which are incorporated herein by reference.

### FIELD OF THE INVENTION

The present invention relates to a parts information management method and a parts information management system.

### BACKGROUND OF THE INVENTION

Heretofore, information management has been implemented in either an electronic or non-electronic manner for each category in a specific organization (for example, in a company) including parts management, production management, parts purchase management, cost management, sales management, quality management, clientele claims management and the like. The information thereon has been mutually referred between a plurality of management systems to satisfy their respective objects. However the information was not gathered in order to make use for the development of new products.

In addition, public networked parts (i.e., Internet) information systems and electronic brochures used by everyone, as well as those used by some specific clients (i.e., extranet) have been used, case by case, for product development. However these systems have not been used with an organization's management system, as described above, for product development. For these reasons, a developer might have difficulty in gathering information, resulting in an unintended increase of processing steps, increase of management cost due to increase of unwanted types of parts, and an irrational design due to the lack of information.

On the other hand, to integrate into a product design any atypical knowledge, experiences, and know-how tips possessed by each of experts with respect to the production, sales, maintenance of products, including the cost, product, quality and schedule management and the like, the designer-developer had to impart his/her intention to experts each specialized in their respective service by way of for example creating a preliminary version of a design drawing or circuit diagram and show them to extract atypical knowledge, experiences, and know-how tips possessed by each of experts. This approach is iterative and delays the development period of a new product and optimal timing of sale which may lead to loss of opportunity, or disadvantage in cost and quality of products due to insufficient examination of the optimal design.

### SUMMARY OF THE INVENTION

The present invention overcomes the above described drawbacks by providing a parts information management method and a parts information management system which allows efficient and optimal activity to be done when developing a new product or improving an existing product.

According to a first and twelfth aspect of the present invention, once part specification information of parts being searched for is input, any parts which satisfies this information is gathered from within a parts information network, and a plurality of parts are listed based on a predetermined priority order. Thus, the result of gathered information required during product, developer or improver activities is a good decision for workers.

According to second and thirteenth aspects of the present invention, the evaluation result in a specific organization is of priority. More specifically, according to a third and fourteenth aspect of the present invention, evaluation within a specific organization may be based on the actual distribution records, and then according to a fourth and fifteenth aspects, the distribution records may be defined by the start and the quantity of distribution.

According to fifth and sixteenth aspects of the present invention, it may be desirable to give classification on the attribute of parts a second priority to the distribution records. More specifically, according to sixth and seventh aspects of the present invention, the part attribute classification is prioritized from higher to lower according to the standardized parts most commonly used, standard parts widely used, then recommended parts frequently used, and finally any other generic parts.

In addition, according to seventh and eighteenth aspects of the present invention, when the parts information network is constructed by a parts information network in a specific organization and a parts information network outside the organization, any necessary information existing in the specific organization may be integrated with any necessary information obtainable from some external source outside the organization such as electronic networks, and the integrated information may be provided in an appropriate form ready for decision making.

On the other hand, according to eighth and nineteenth aspects, a specific department in an organization may select a group of parts from the parts information network to create a list of parts. Then, a specialized department related to the specific department may use the network to examine the parts list made by the specific department to send back the result of examination to the specific department.

Where the optimal design is not achievable only with the formalized information, an effective and optimum design of a product may be provided by using the network to share the atypical knowledge, experiences, and know-how tips of experts with respect to the production, sales, maintenance of products. This Includes the cost, product, quality and schedule management and the like. In this manner, an effective, efficient and optimal activity may be provided at the time of development or improvement of a product.

According to a ninth and a twentieth aspect of the present invention, after examining the parts list created by a specific department, a specialized department creates another parts list after considering the results of examination, such that the specific department selects parts based on the parts list modified by the specialized department. According to a tenth and twenty-first aspects of the present invention, the parts list is rearranged from the specific department to the specialized departments to be prioritized for each specialized departments.

Furthermore, according to eleventh and twenty-second aspects of the present invention, when the parts information network includes a parts information network in a specific organization and outside the organization, any necessary information existing in the specific organization may be integrated with any necessary information obtainable from some external source outside the organization such as electronic networks, and the integrated information may be provided in an appropriate form ready for decision making.

Further areas of applicability of the present invention will become apparent from the detailed description provided hereinafter. It should be understood that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a schematic block diagram of the parts information management system according to the present invention;

FIG. 2 is a schematic block diagram illustrating the operation and process steps in the parts information management system according to the present invention;

FIG. 3 is an example display screen of a display device according to the present invention;

FIG. 4 is an example display screen of a display device according to the present invention;

FIG. 5 is an example display screen of a display device according to the present invention;

FIG. 6 is an example display screen of a display device according to the present invention;

FIG. 7 is an example display screen of a display device according to the present invention;

FIG. 8 is an example display screen of a display device according to the present invention;

FIG. 9 is an example display screen of a display device according to the present invention;

FIG. 10 is a table describing display contents according to the present invention;

FIG. 11A is a table describing display contents according to the present invention; and

FIG. 11B is a table describing display contents according to the present invention.

### DETAILED DESCRIPTION OF THE PREFERRED EMBODIMENTS

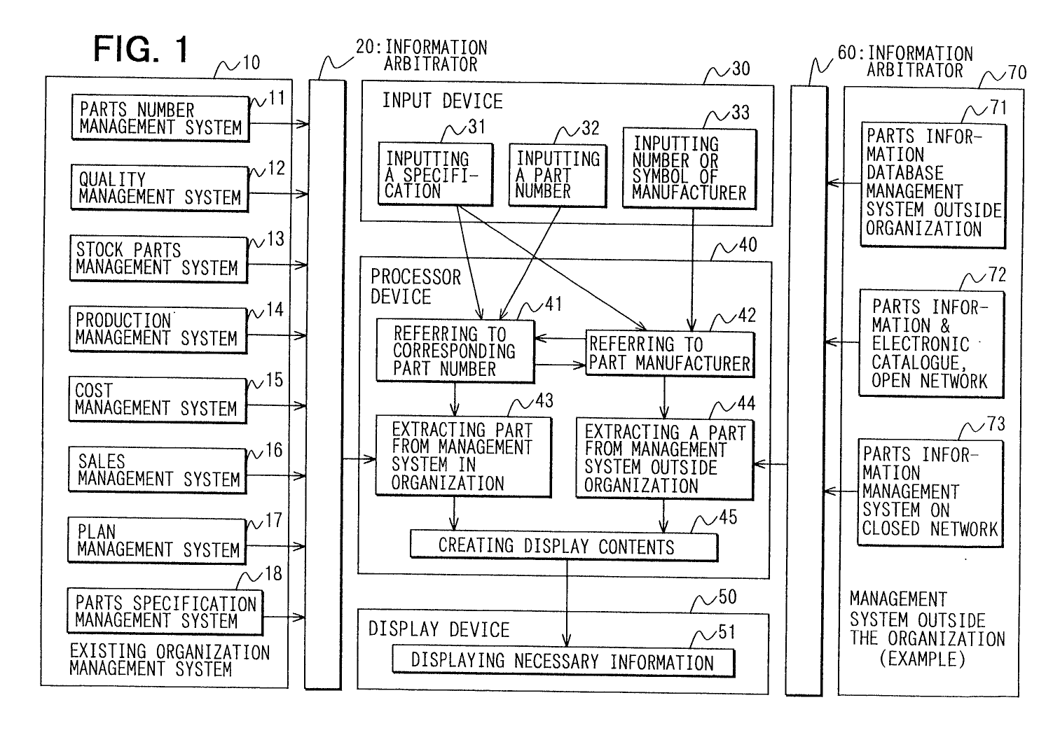

FIG. 1 shows a schematic block diagram of a parts information management system according to the preferred embodiment of the present invention. In FIG. 1, an existing management system 10 in an organization is shown comprising a parts number management system 11, a quality management system 12, a stock parts management system 13, a production management system (distributed parts management system) 14, a cost management system 15, a sales management system 16, a plan management system 17, and a parts specification management system 18. The existing management system 10 is connected to a processor 40 through an information arbitrator 20. The processor 40 is further connected to input devices 30 and to a display device 50. The input devices 30 may include a keyboard and a mouse or the like, the processor 40 may include a CPU, and the display device 50 may include a display or the like.

A terminal of the parts information management system includes the processor 40, input device 30, and display device 50. There will be a number of such terminals provided and installed in each specific department such as development and design in a specific organization, which may be a company, as well as in each specialized department in response to the specific departments mentioned above, such as quality control, production management, cost management and the like.

In FIG. 1 there is also shown as a management system 70 outside the organization, including a parts information management database system 71, parts information/electronic catalog 72 on an open network (such as the Internet), a parts information management system 73 on a closed network exclusive for some specific organizations. the management system 70 outside the organization is connected to the processor 40 through an information arbitrator 60. The information arbitrator 20 and 60 may be comprised of a server hardware and server software.

As described above, the parts information network according to the preferred embodiment of the present invention is comprised of a parts information network in the specific organization and a parts information network outside the specific organization.

In this arrangement, a worker may input to the input device 30 (such as a terminal of the parts information management system) part specifications (reference numeral 31 in the figure) or a part number (reference numeral 32), or a symbol or number of parts manufacturer (reference numeral 33). Then, in response to the input, the processor 40, (which constitutes a component of the terminal of the parts information management system) will perform a collation of corresponding part number (reference numeral 41 in the figure), or a reference of the number of parts manufacturer (reference numeral 42). The processor 40 will extract parts that may satisfy the specification from the existing management system 10 in the organization (reference numeral 43), as well as extract parts that may satisfy the specification from the management system 70 outside the organization (reference numeral 44). In addition, the processor 40 will arrange the display of extracted results, which may conform to a display rule. The display device 50, (which is a component of the terminal in the parts information management system) will display the required information (reference numeral 51 in the figure).

As can be appreciated, the parts information management system according to the preferred embodiment displays necessary information corresponding to certain specific rules with respect to the handling of formalized parts information, by integrating information found in an information system constructed for a various purpose in a specific organization as well as in the electronic network outside that organization, and by selecting based on part specifications or parts numbers. In other words, by using this parts information management system to promptly retrieve parts which may satisfy a desirable specification (for example, resistance, voltage limit, quality or price of electronic parts) and then display various information with respect to thus found parts at the same time, process steps of developers and improvers of a product may be decreased and the number and type of parts may be curtailed (by use of common and standardized parts), decreasing cost of products and parts and lowering management cost.

In addition, the parts information management system shares any atypical knowledge, experiences, and know-how tips possessed by each expert with respect to the production, sales, and maintenance of products, including the cost, product, quality and schedule management and the like. In other words, by integrating any atypical knowledge, experiences, and know-how tips possessed by each of experts with respect to the production, sales, maintenance of products, including the cost, product, quality and schedule management and the like, effective and optimal activity of product design may be achieved.

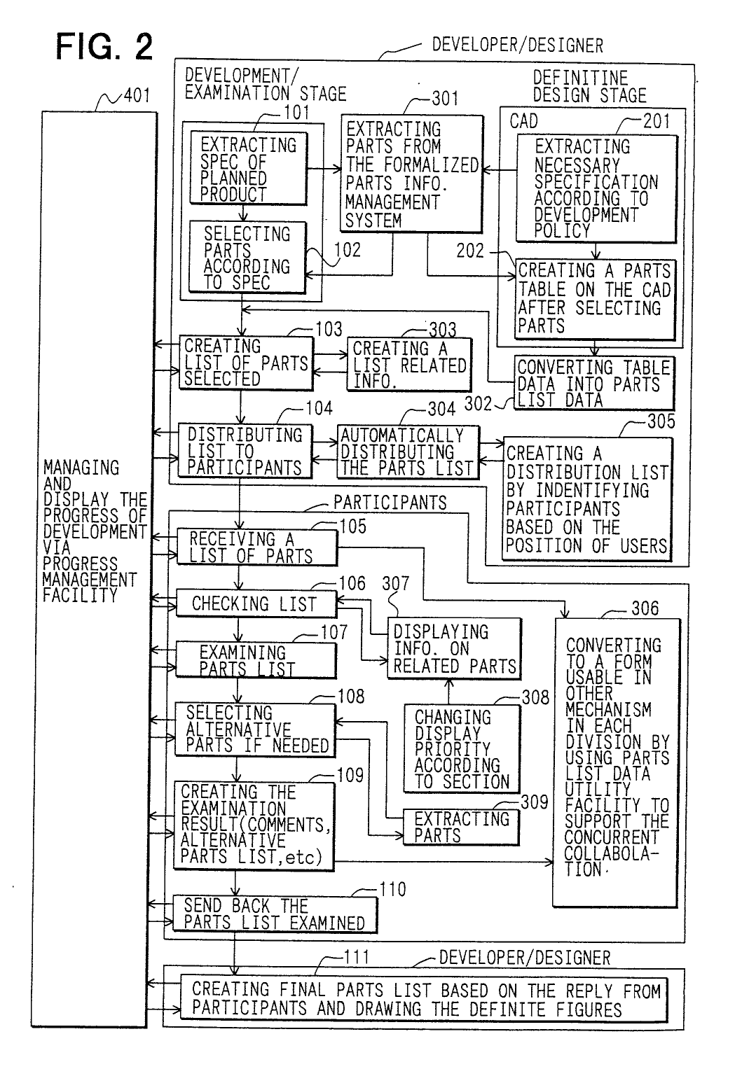

Referring to FIG. 2, process steps and the operation of system will be described in greater details herein below. In FIG. 2, reference numerals 101 through 111 and 201 and 202 designate manual activities, reference numerals 301 through 309 designate processing by the processor 40 in a network terminal, and 401 designates the administration and display of the progress along with the maneuver and processes by way of the progress management facility of the system.

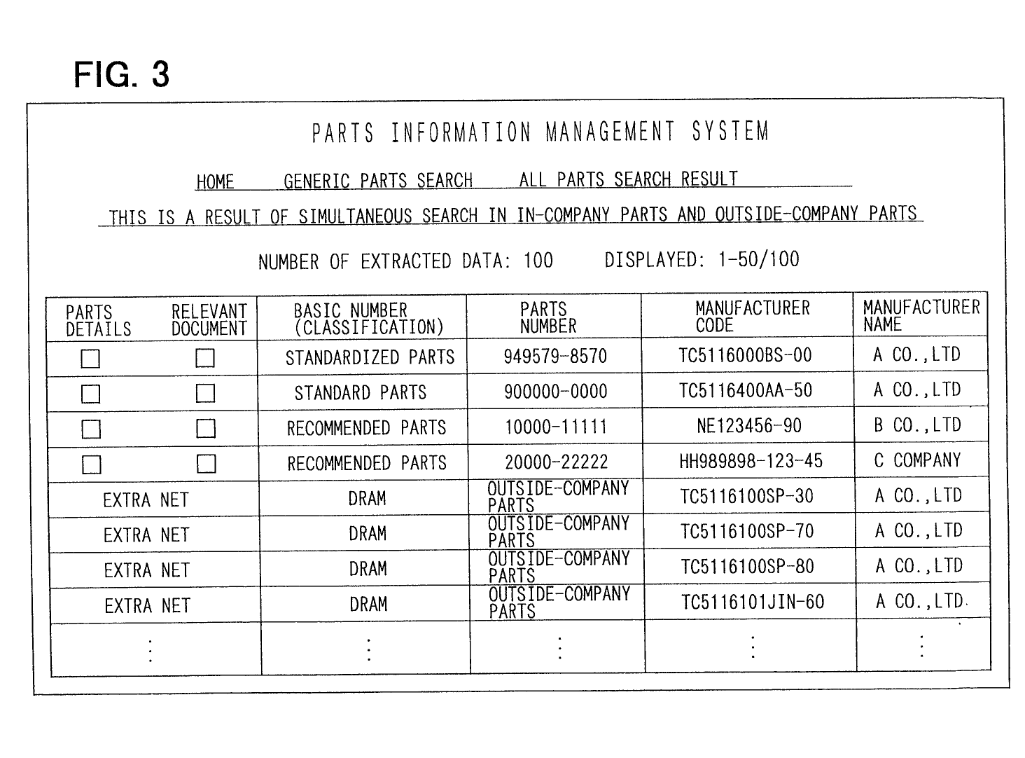

In FIG. 2, a developer or designer performs the activity shown in reference numerals 101 and 102 during development and investigation. At first in step 101, any necessary part specifications will be extracted in correspondence with the product design. At this time the processor 40 of FIG. 1 will extract parts with the formalized parts information management system, as shown by the reference numeral 301 of FIG. 2. In other words, as described above, the developer or designer inputs part specification information (for example, parts numbers, manufacturer identification symbol, manufacturer identification number, and the like) by using the input device 30 shown in FIG. 1. Then, the processor 40 extracts part information (on the parts information network) from the existing management system 10 in the organization and the management system 70 outside the organization to display search results on the display device 50. When retrieving and displaying parts possibly satisfying the requested specification, the system will display a list having a plurality of parts in a predetermined priority order. A typical example of display contents is shown in FIG. 3.

According to the preferred embodiment, the parts information network includes a parts information network in a specific organization and a parts information network of the external source. So, important information present in the specific organization as well as any information obtainable from external sources outside the organization, such as electronic networks, may be integrated to provide in an appropriate form for easily making decisions.

The process of parts retrieval and listing display will be described in greater details below. For the parts information already formalized, any parts information required for the product developers and improvers (parts information including such as size, weight, precision, characteristics, form, price, quality, distribution records, compatibility, and the like) will be gathered from information systems already built around, inside and outside a specific organization. At this time, retrieval may be performed by using specification keywords if the retrieval information system allows specification search. On the other hand, the specification may need to be modified to correspond to part numbers in another information system prior to search by using the parts numbers as keywords, if the information system cannot handle the specification information such as the cost, quality, schedule, and the like.

Where the part numbers used in the specific organization are different from the part numbers or model numbers supplied from out-source suppliers such as manufacturers, the numbers will be automatically converted by referring to a translation table. When there are a plurality of parts gathered, parts having part numbers thereof listed in the information system of the specific organization will precede them. The priority order when listing a plurality of parts will be determined such that the evaluation result in the specific organization comes before any other parts. More specifically, the evaluation in the specific organization may be based on the distribution records. By referring to FIG. 3, four entries in the list are shown having certain distribution records, and are given with their in-house part numbers. These distribution records are regulated by the start and the quantity of the distribution. The earlier the start of distribution and the larger the quantity is, the higher the priority.

The reason why distribution records are dealt with is that the potential of quality, supply, availability of the parts in question may be estimated as more stable if the parts in question are long supplied, or in large quantity. By knowing the supplier's faculty, production line, and used materials, it will be easier to estimate how far the usage condition of the parts in question is analogous, and such information will considerably affect the decision of adopting the parts in question at the time of product development.

The classification of parts' attributes (classification by the attributes of the parts) is given second priority next to the distribution records in the evaluation in the specific organization. More specifically, if there are a plurality of parts (or part numbers) found in the information system in the specific organization, the priority order will be determined according to the distribution records, priority class (classification by the attributes of the parts) in order to display the list.

It should be noted here that the priority class (the classification by the attributes of the parts in question) includes in the following order:

(1) standardized parts: parts extensively sold in the market as versatile parts, the specification of which is defined (determined) by the supplier—parts most widely used.

(2) standard parts: parts decided to be used antecedently in the organization, to reduce the parts management cost and the purchase cost, improve quality, stabilize supply, etc.—parts widely used next to the standardized parts.

(3) recommended parts: parts defined as antecedently in a specific department of the organization—parts frequently used next to the standard parts.

(4) generic parts: any other commonly used parts—common parts.

The order above is used for priority.

Referring to FIG. 3, the standardized parts are listed at the topmost row, the standard parts are listed in second row, the recommended parts are listed in the third and fourth rows, and common parts are at the bottom. According to the preferred embodiment of the present invention, the input device 30 shown in FIG. 1 has an input device attached to a network terminal for inputting information with respect to part specifications searched. The display device 50 has a display means attached to a network terminal for displaying a listing of parts after gathering information on the parts that may satisfy the specification in the predetermined priority order.

Now returning to FIG. 2, the developer/designer will select (decide to use) some parts according to the specification thereof, as shown by the reference numeral 102 in FIG. 2.

If the design stage is final, a CAD activity as shown by reference numerals 201 and 202 in FIG. 2 is performed. At step 201, the required specification is extracted based on the design policy. At the step 202, parts are selected to create a constituent list on CAD. In this step the processor 40 shown in FIG. 1 converts the data from the constituent list into the parts list, as shown by the reference numeral 302 in FIG. 2.

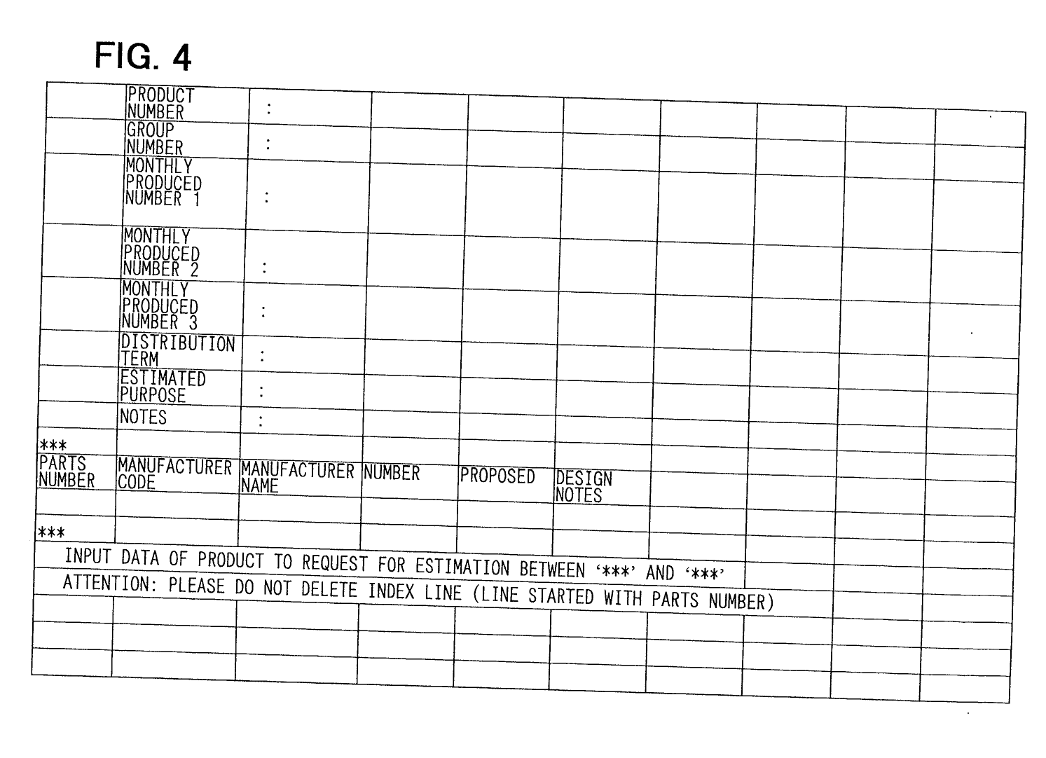

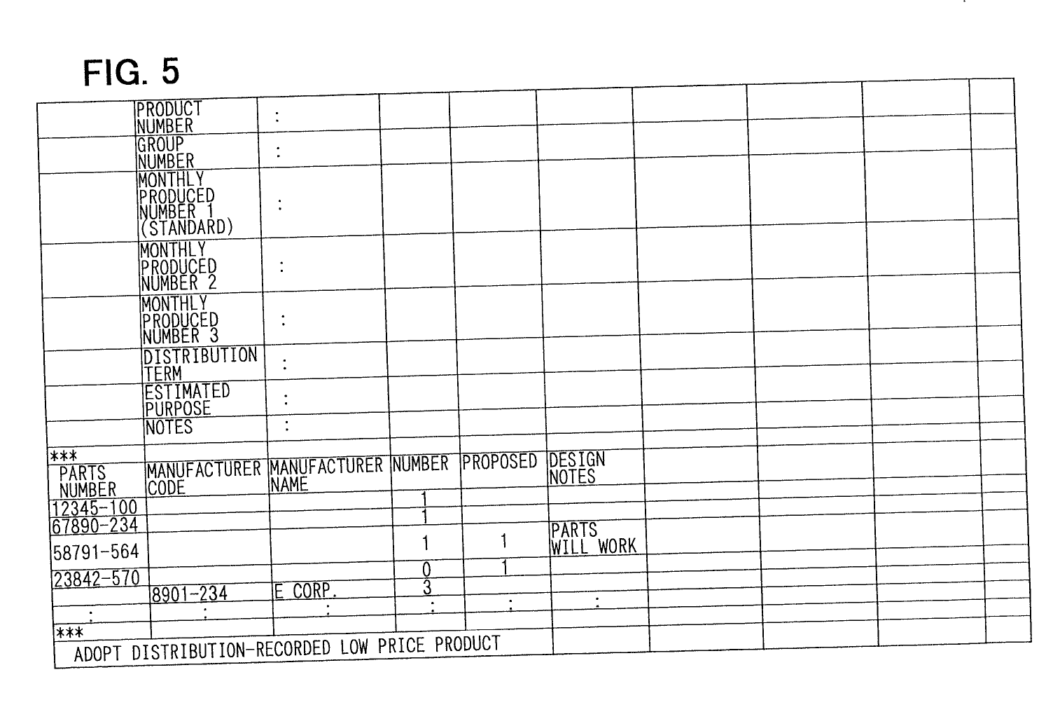

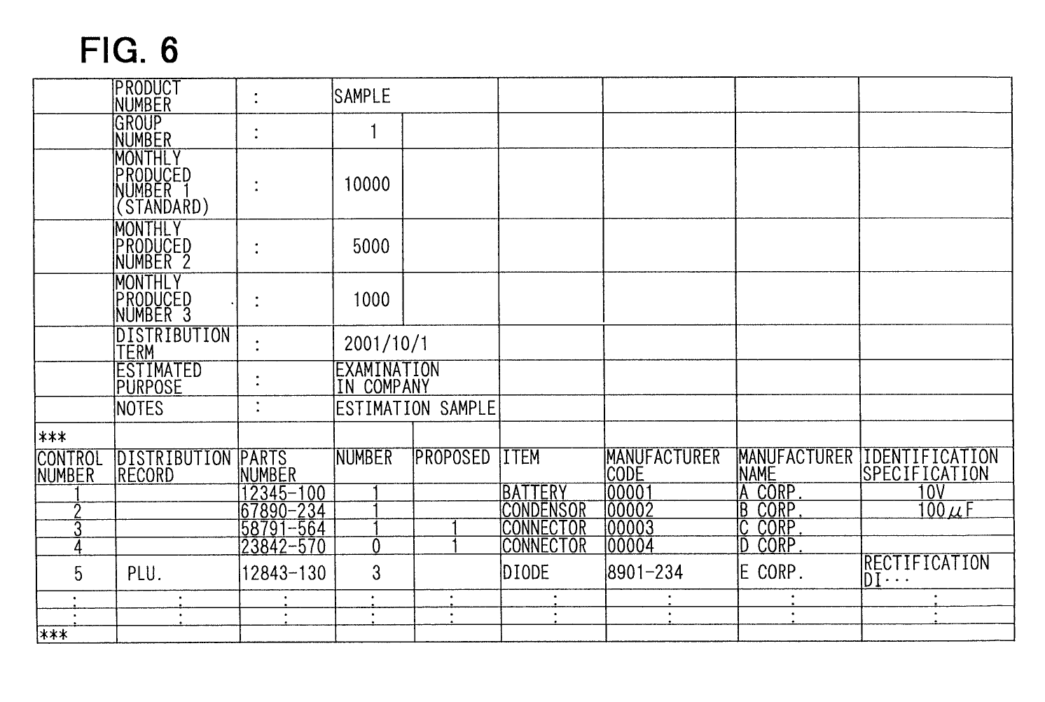

Then, the developer/designer will create a list of selected parts as shown by reference numeral 103 in FIG. 2. More particularly, a parts list shown in FIG. 5 will be created by inputting any necessary data on the screen shown in FIG. 4. In this step, the processor 40 of FIG. 1 will generate a list including information in relation to the part numbers by way of parts list generator facility, as shown by reference numeral 303 in FIG. 2. More particularly, as shown in FIG. 6, the data including the distribution records, item description, manufacturer symbol will be added.

Then, the developer/designer will distribute the list of selected parts to the parties concerned, as shown by the reference numeral 104 in FIG. 2. At this time, the processor 40 shown in FIG. 1 will automatically distribute the parts list with the distribution facility, as shown by the reference numeral 304 in FIG. 2, while at the same time creating a distribution list by automatically identifying the parties concerned based on the section the users belong to.

Thereafter, upon reception (reference numeral 105 of FIG. 2) of the parts list, the participants (specialized departments) will check the list of selected parts (reference numeral 106). Then the participants will take into consideration the situation of their own department, so as to examine whether or not the selected parts listed should be adopted or not (reference numeral 107). The participants may or may not select alternative parts if required (reference numeral 108), then write the result of examination (including any comments, list of alternative parts, and the like) (reference numeral 109) to send back to the originator the proof list of parts (reference numeral 110).

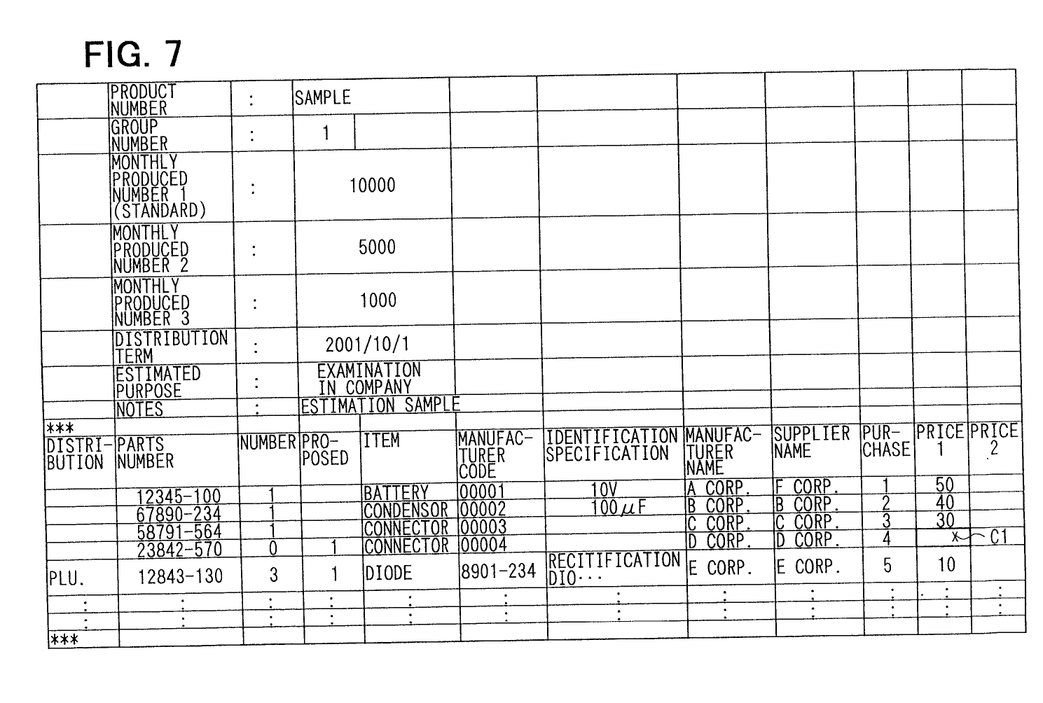

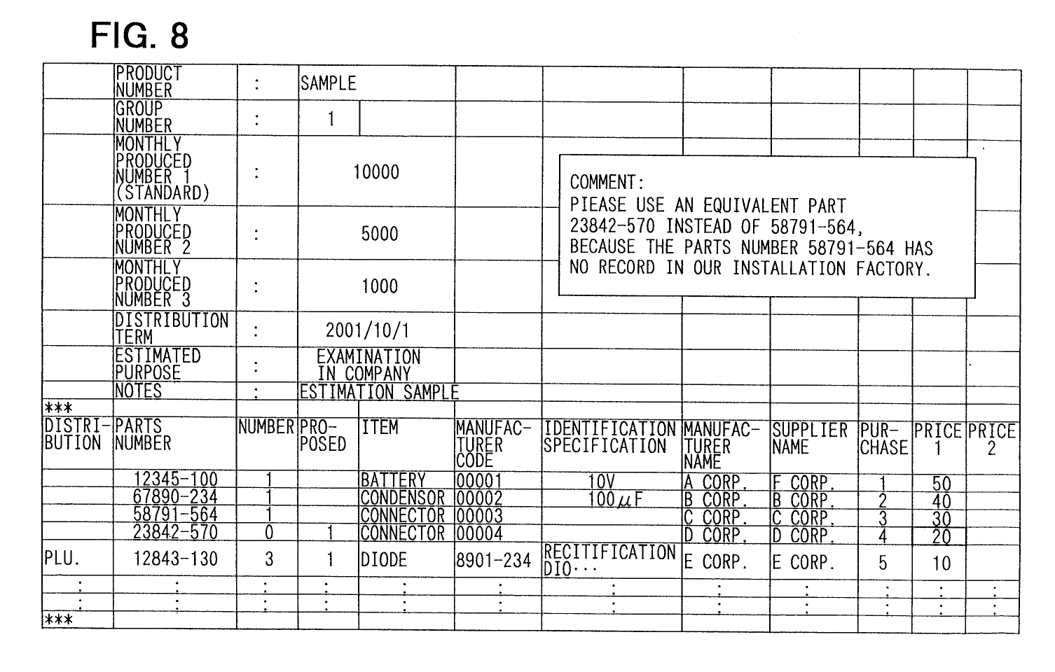

The activity at the participants (specialized departments) more practically may be as follows. For example, on the display screen shown in FIG. 7, the value of unit price in the cell C1 may be modified to a new value as shown in FIG. 8 (“20” in FIG. 8), or a comment may be added telling that “please use an equivalent part 23842-570 instead of 58791-564, because the parts number 58791-564 has no record in our installation factory”.

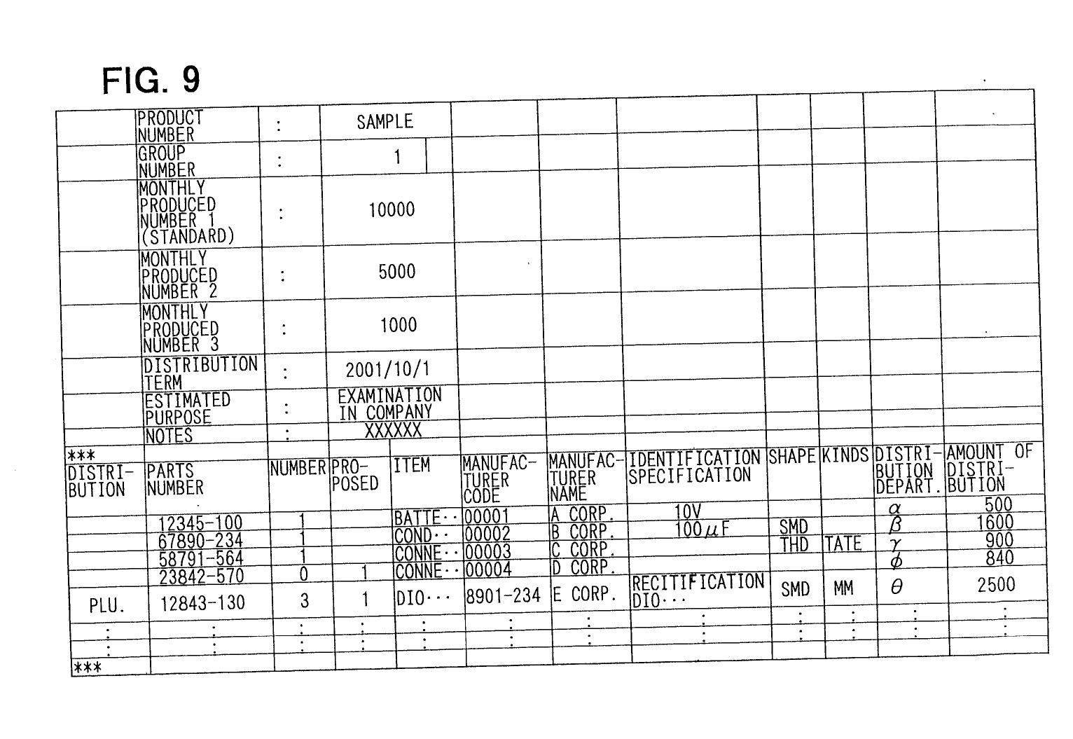

In the sequence described above, the processor 40 shown in FIG. 1 will display the parts information related to the formalized parts by the information management system as shown by reference numeral 307 in FIG. 2, while checking the parts list at the step 106 in FIG. 2. At this time the priority order of display will be modified for each department (reference numeral 308). More specifically, the parts list from a specific department to a specialized department will be prioritized suitable for each specialized department. More practically, as shown in FIG. 9, the list will be displayed with part numbers, supplier symbols, names of manufacturer, form, distribution department, quantity of supply, and the like for the production/quality assurance department. The processor 40 shown in FIG. 1 will extract parts by means of formalized parts information management system as shown by reference numeral 309 in FIG. 2, at the time of selection of alternative parts in the step 108 of FIG. 2. Moreover, the processor 40 of FIG. 1 will convert the list to a form usable in other mechanisms in each division by means of utility facility of parts list data in order to support the concurrent collaboration by any divisions, as shown by reference numeral 306 of FIG. 2, at the time of reception of list and creation of list in the steps 105 and 109 of FIG. 2.

When the participants (specialized departments) send back the list, the information with respect to the related parts will be always automatically updated to the latest data.

Next, the developer/designer will create the definitive parts list based on the replies from the participants as shown by reference numeral 111 of FIG. 2 to start drawing.

As can be seen from the foregoing description, a specific department in an organization may select a group of parts from the parts information network to create a list of parts. Specialized departments in relation to the specific department will in turn examine the created list of parts by the specific department with the network to send back the result of examination to the specific department. More specifically, the specialized departments will examine the list of parts created by the specific department to create a list of parts modified by adding the result of examination, then the specific department will select again a group of parts based on the parts list modified by the specialized departments. Then, if the optimal design is not possible by relying on the formalized information, an effective and optimum design of a product may be provided by using the network to share this atypical knowledge, experiences, and know-how tips of experts with respect to the production, sales, maintenance of products, including the cost, product, quality and schedule management and the like. In this manner, an effective, efficient and optimal activity may be provided at the time of development or improvement of a product. Since the parts information network is comprised of a parts information network in the specific organization and a parts information network outside the specific organization, various important information present in the specific organization as well as any information obtainable from external sources outside the organization such as electronic networks may be integrated to provide in an appropriate form for easily making decisions.

According to the preferred embodiment, the parts information management system which integrates networked parts information, the input device 30, processor 40, and display device 50 will cooperate to use the network to form a parts list generator means for selecting a group of parts from the parts information network at a specific department for creating a list of parts. In addition, the input device 30, processor 40, and display device 50 will cooperate to form a sending back means for sending back the result of examination on the list of parts created by the specific department from the specialized departments in relation to the specific department to the specific department. Moreover, the input device 30, processor 40, and display device 50 will cooperate to form a parts list generator means for creating a list of parts modified by adding the result of examination after the specialized departments have been examined the list of parts created by the specific department, as well as to form a reselection means for selecting once again a group of parts based on the list of parts modified by the specialized departments at the specific department. Finally, the processor 40 will be used to form a rearranging means for rearranging the list of parts from the specific department to any specialized departments according to the priority order in each of specialized departments.

As can be appreciated from the foregoing description, in brief, from the consideration of cases where driving the parts information may or may not lead to an optimal design due to the lack of the latest condition in each section, specialized knowledge, experiences, and know-how tips that cannot be formalized, the present invention will attempt to compensate for these disadvantages by providing the steps of creating a list of parts that lists part numbers and parts information in a form of parts list of a group of parts selected by using the facility for dealing with the formalized parts information prior to drawing the definitive design, simultaneously distributing the list to any relational specialized departments, examining the list of parts at the specialized departments, sending back the list after adding the latest advice according to the specialized knowledge, experiences, and know-how tips, and selecting once again alternative parts according to the comments fed back from the relating specialized departments to achieve a product development with concurrency based on the intelligence gathered from the entirety of specific organization.

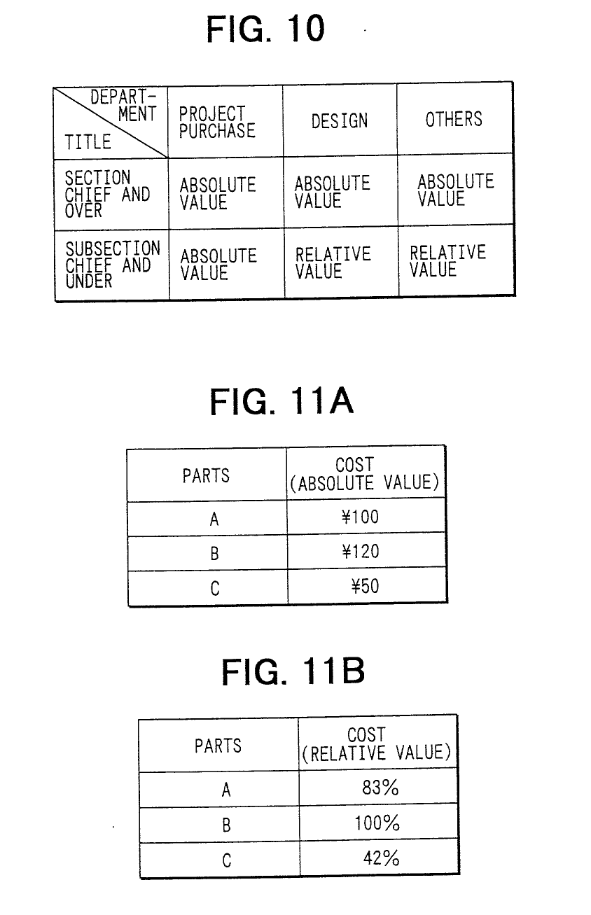

The system may be operated by applying regulations as rules to each piece of information so as to integrate the security levels, since each piece of information has a limitation of disclosure respectively. More specifically, as shown in FIG. 10, in correspondence with the department and the position rating therein, either the absolute values or relative values will be displayed. Here, displaying the absolute values mean that the prices of parts are to be displayed as the absolute price rate (unit price of yen), as shown in FIG. 11 (a), while displaying the relative values means that the prices of parts are displayed as the relative rate (percentage rating) as shown in FIG. 11 (b). In FIG. 11, the most expensive parts B among parts A, B, and C, is used as the reference (100%) rating in order to express respective relative values for parts A and C. In FIG. 10, the departments that deal with the cost prices such as planning office and purchase department for example, may see the absolute values without reference to the position due to the characteristics of their activity, however the display will be either the absolute values for section chief and higher or the relative values for subsection chief and lesser in any other sections including designing. The reason is that, absolute values are displayed on the eyes of section chiefs and higher who need to bear the responsibility of costs, and relative ratings are displayed for the practical workers (any departments including design other than the planning and purchase) below subsection chiefs in order to raise the consciousness on the cost.

While the above-described embodiments refer to examples of usage of the present invention, it is understood that the present invention may be applied to other usage, modifications and variations of the same, and is not limited to the disclosure provided herein.

What is claimed is:

1. A parts information management method, comprising the steps of:
inputting part specification information into a parts information network;
gathering parts information that satisfies the part specification information from the parts information network; and
displaying a list of parts in an order of predetermined priority.

2. A parts information management method set forth in claim 1, wherein the order of predetermined priority has evaluation results in a specific organization set at a top of the list.

3. A parts information management method set forth in claim 2, wherein the evaluation results in the specific organization are based on an actual distribution.

4. A parts information management method set forth in claim 3, wherein actual distribution records are regulated by a start and quantity of distribution.

5. A parts information management method set forth in claim 3, wherein the evaluation in the specific organization has a part attribute classification set of a second priority of the list following the actual distribution.

6. A parts information management method set forth in claim 5, wherein the part attribute classification is prioritized from higher to lower in an order of:
standardized parts most widely used;
standard parts widely used;
recommended parts frequently used; and
any other generic parts.

7. A parts information management method set forth in claim 1, wherein the parts information network is comprised of a parts information network in the specific organization and a parts information network outside the specific organization.

8. A parts information management method, comprising the steps of:
generating a list of parts based on a selection of a group of parts from within a parts information network by a specific department in a specific organization; and
using the network by a specialized department in relation to the specific department to examine the list of parts to generate and provide an examination result to the specific department having created the list of parts.

9. A parts information management method set forth in claim 8, wherein:
the specialized department examines the list of parts created by the specific department to create a list of parts having the result added; and
the specific department selects a group of parts based on the list of parts created by the specialized department.

10. A parts information management method set forth in claim 8, wherein the list of parts generated by the specific department is prioritized for each specialized department.

11. A parts information management method set forth in claim 8, wherein the parts information network is comprised of a specific organization parts information network and a parts information network outside the specific organization.

12. A parts information management system, comprising:
input means provided in a network terminal for inputting part specification information to be searched; and
display means provided in the network terminal for displaying a list of parts in a predetermined order after gathering said parts from a parts information network, wherein the parts satisfy said part specification information input from the input means.

13. A parts information management system set forth in claim 12, wherein the predetermined order prioritizes the list in a specific organization set at a top of the list.

14. A parts information management system set forth in claim 13, wherein the list is prioritized according to an actual distribution.

15. A parts information management system set forth in claim 14, wherein actual distribution records are regulated according to start and quantity of distribution.

16. A parts information management system set forth in claim 14, wherein evaluation in the specific organization has the part attribute classification set at a second priority of the list following the actual distribution.

17. A parts information management system set forth in claim 16, wherein the part attribute classification is prioritized from high to low according to:
standardized parts most widely used;
standard parts widely used;
recommended parts frequently used; and
any other generic parts.

18. A parts information management system according to claim 12, wherein the parts information network includes a parts information network in the specific organization and a parts information network outside the specific organization.

19. A parts information management system for networking parts information, comprising:
parts list generating means for creating a list of parts based on a selection of a group of parts from a parts information network of a specific department; and
sending back means that uses the network to send back to the specific department the result of examination by a specialized department in relation to the specific department on the list of parts.

20. A parts information management system set forth in claim 19, wherein:
the sending back means comprises a parts list generating means for creating a list of parts having the result of examination added after the examination by the specialized department on the list of parts created by the specific department; and
a reselection means for selecting a group of parts based on a list of parts created by the specialized department at the specific department.

21. A parts information management system set forth in claim 19, wherein:
the information management system further comprises a rearrangement means for arranging the list of parts sent from the specific department to the specialized department so as to be in the priority order for each of specialized departments.

22. A parts information management system set forth in claim 19, wherein:
the parts information network includes a parts information network in the specific organization and a parts information network outside the specific organization.
